(19) United States
(12) Patent Application Publication
(10) Pub. No.: US 2008/0264803 A1
(43) Pub. Date: Oct. 30, 2008

(54) Methods and Apparatus for the Storage of Acetylene in the Absence of Acetone or Dimethylformamide

(76) Inventor: Rajat Agrawal, Newark, DE (US)

Correspondence Address: AIR LIQUIDE;Intellectual Property, 2700 POST OAK BOULEVARD, SUITE 1800, HOUSTON, TX, 77056, US

(21) Appl. No.: 12/106,884

(22) Filed: Apr. 21, 2008

Related U.S. Application Data
(60) Provisional application No. 60/913,203, filed on Apr. 20, 2007.

(51) Int. Cl. C10L 3/04; F17C 11/00

(52) U.S. Cl. 206/7; 141/9; 95/145

(57) ABSTRACT

Methods and apparatus for storing and providing acetylene. A storage vessel contains both a porous filler material and an ionic liquid based solvent. Acetylene is dissolved into the solvent, and stored inside the storage vessel. The solvent contains no acetone or dimethylformamide.

### CROSS REFERENCE TO RELATED APPLICATIONS

The present application claims the benefit of U.S. Provisional Application Ser. No. 60/913,203, filed Apr. 20, 2007, herein incorporated by reference in its entirety for all purposes.

### BACKGROUND

1. Field of the Invention

This invention relates generally to the distribution of acetylene. More specifically, the invention relates to a method and apparatus for storing acetylene.

2. Background of the Invention

Acetylene is conventionally stored in cylinders filled with a porous media which contains a solvent such as acetone or dimethylformamide (DMF) into which acetylene is dissolved. This is a common practice utilized to prevent dissociation of acetylene (free acetylene) during long term storage which can happen between production and usage because of delivery, for example. The dissociation of acetylene can occur at pressure above 15 psig and result in heat generation, temperature rise and possible explosion.

When storing acetylene in acetone or DMF, it is likely that when the acetylene is withdrawn from the cylinder a small quantity of the solvent is also entrained. The quantity of solvent entrained is a function of cylinder pressure, temperature and the flow rate at which acetylene is withdrawn from the cylinder and can also change as the amount of acetylene decreases in the cylinder. For example, when acetone is used as a solvent, the concentration of acetone in acetylene can be in the range of 0.1% to 1% and depending upon the flow rate as high as 10%. The presence of solvent in acetylene can be quite detrimental to some processes used in the chemical and semiconductor industries which require high purity acetylene or use acetylene as a raw material to make other products. Many of these processes are operated at very high temperatures, of the order of 1000° C. At these temperatures, presence of acetone will result in formation of oxygen and other byproducts which can be highly undesirable from process point of view. Additionally, because of gradual loss of acetone, the cylinders need to be recharged with acetone requiring taking the cylinders out of service.

Consequently, there exists a need for storing acetylene in the absence of acetone or DMF.

### BRIEF SUMMARY

Novel methods and apparatus for the storage of acetylene. The disclosed methods and apparatus utilize a storage vessel, a filler material located within the storage vessel, and an ionic liquid based solvent.

In an embodiment a method for storing acetylene comprises providing a storage vessel, and providing a filler material into the interior of the storage vessel. An ionic liquid based solvent is provided into the interior of the vessel, where it is in contact with the filler material. The storage vessel is then filled with acetylene, while the pressure in the storage vessel is maintained at less than about 350 psig.

Other embodiments of the invention may include, without limitation, one or more of the following features:
the filler material is introduced into the storage vessel as an aqueous slurry of silica lime or a ceramic, and the water is removed from the slurry though the addition of heat leaving behind a porous filler material structure with a density of about 8-20% of the volume of the storage vessel;
the ionic liquid is provided in the amount of about 25% to about 90% of the volume of the storage vessel;
the acetylene is dissolved into the ionic liquid solvent through contact;
acetylene is withdrawn from the storage vessel, its pressure is reduced and it is provided to a semiconductor manufacturing process;
the reduced pressure acetylene is purified;
an amount of acetylene between about 0.20 to about 0.60 grams per gram of ionic liquid solvent is dissolved, as measured at about 250 psig;
the ionic liquid based solvent comprises a cation component and an anion component;
the anion component comprises is selected from chlorides, bromides, iodides, thiocynates, alkylsulfates, hydrogensulfates, and fluorine substituted compounds (e.g. tetrafluoroborates, hexafluorophosphates, trifluoromethanesulfonates, or trifluoroacetates); and
the cation component comprises a nitrogen or a phosphorus based compound, preferably, one of mono-substituted imidazoliums, di-substituted imidazoliums, tri-substituted imidazoliums, substituted pyridniums, substituted pyrrolidiniums, tetraalkyl ammoniums, and phosphoniums.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DESCRIPTION OF PREFERRED EMBODIMENTS

Generally, embodiments of the current invention relate to methods and apparatus for the storage of acetylene. The disclosed methods and apparatus utilize a storage vessel, a filler material located within the storage vessel, and an ionic liquid based solvent.

In some embodiments, acetone (or DMF) entrainment in acetylene may be avoided by replacing acetone with another solvent such as an ionic liquid. One of the interesting properties of ionic liquids is that they have negligible vapor pressure making them an attractive alternative solvent compared to conventional solvents such as acetone. An ionic liquid based solvent can prevent entrainment of solvent resulting in a purer product as well as eliminating the need to periodically recharge the cylinder with the solvent. Ionic liquids can be classified as organic salts that are liquid at ambient conditions of temperature and pressure. Ionic liquids typically consist of an inorganic anion and an organic or inorganic cation and typically have melting point below 100° C. Because of the strong interaction between cations and anions, ionic liquids have negligible vapor pressure and are considered non-volatile which differentiates them from conventional molten salts which require high temperatures (250° C. for sodium chloride, for example) to keep them in the liquid state. There are many ionic liquid based solvents available commercially which stay liquid at room temperature called “room temperature ionic liquid (RTIL).

In some embodiments, the storage vessel is a convention type gas storage cylinder. The acetylene cylinder contains a filler material and may have an isolation valve attached to the cylinder outlet. The filler material is a porous material consisting of silica lime or ceramic and may contain additives such as charcoal.

In some embodiments, the filler material is selected in such a way that it provides a light weight structure with high porosity and has a density of about 8-20% of the volume in cylinder. The filler material is normally forced into the empty cylinder in an aqueous slurry form followed by removal of water by applying heat and pressure. Once the water is removed, a concrete like porous structure is formed with significant free volume. A cylinder valve may then be attached to the cylinder.

In some embodiments, an ionic liquid based solvent comprising a cation and an anion is charged into the cylinder so as to completely fill the pores of the filler material. The cylinder may be charged at a slightly elevated pressure to expedite the process. The amount of ionic liquid filled in the cylinder is in the range of 0.25-0.90 lit/lit of the cylinder volume at ambient temperature and pressure conditions. In some embodiments, the ionic liquid is selected in such a way that it can dissolve 0.20 to 0.60 gram of acetylene per gram of solvent at storage pressure conditions of around 250 psig. In some embodiments the anion component of the ionic liquid is chosen in such a way so as to impart acidic, basic, or neutral properties. For example, ionic liquids containing a basic anion may be better to store acetylene which is acidic in nature (pKa of acetylene is 25). Some of the examples of anion species are chlorides, bromides, iodides, thiocynates, alkylsulfates, hydrogensulfates, and fluorine substituted species such as tetrafluoroborates, hexafluorophosphates, trifluoromethanesulfonates, and trifluoroacetates. The cation components of the ionic liquid typically may contain nitrogen or phosphorus and examples include mono- di- and trisubstituted imidazoliums, substituted pyridiniums, substituted pyrrolidiniums, tetraalkyl ammoniums, and phosphoniums.

In some embodiments, the free acetylene may be introduced into the cylinder containing the filler material soaked with the ionic liquid whereby acetylene is dissolved into the ionic liquid. Contacting the acetylene with the ionic liquid may be accomplished by simply pressurizing the cylinder with acetylene and allowing sufficient time to equilibrate the two components. The pressure inside the cylinder is monitored so as not to exceed the pressure of 300-350 psig. During the dissolution process, significant heat can be generated which may be removed by sprinkling water over the cylinders or using other means for cooling (e.g cooling through convection with air). Once the desired equilibrium pressure is reached inside the cylinder the filling process may be stopped. The equilibrium pressure in a cylinder is about 260 psig at 21° C. as per DOT regulations. The acetylene cylinder prepared in this way can be stored for an extended period of time and can be shipped as required.

In some embodiments, an acetylene cylinder prepared in according to the current invention may be used to deliver acetylene to an application requiring high purity acetylene. A pressure reducing means may be in communication with the acetylene storage cylinder valve and maybe used to control the pressure of the acetylene leaving the cylinder. The pressure reducing means can be a pressure regulator which can be preset to fix the pressure downstream of the regulator. In some embodiments, the pressure downstream of the regulator is less than 50 psig and preferably less than 20 psig.

In some embodiments, a purification means may be used to purify acetylene further after it is withdrawn from the cylinder. The purification means may be a filter such as a sintered metal filter or a membrane filter to remove any liquid such as moisture or solid residue such as particles from the acetylene stream. The filter may be selected in such a way so as to keep the pressure drop across the filter to less than about 5 psi and preferably less than about 1 psi. In addition to the filter, the purification means may contain an adsorbent bed or a cartridge such as silica gel or carbon to remove any impurities which may be in the acetylene stream. The purification means may also contain a purifier which is designed in such a way so as to remove selectively an impurity which may be undesirable from the process point of view. Some of these impurities can come from the acetylene manufacturing process (e.g phosphine) which may be removed by using a purification means designed specifically to remove such an impurity. The flow rate of acetylene leaving the purification means may be controlled by a flow controller which may be a mass flow controller or a similar flow control device known to one of skill in the art.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. An apparatus for storing acetylene, comprising:
a) a storage vessel;
b) a filler material disposed within the storage vessel; and
c) an ionic liquid based solvent disposed within the storage vessel.

2. The apparatus of claim 1, wherein the filler material comprises a porous material of silica lime or a ceramic, and where the filler material has a density of about 8-20% of the volume of the storage vessel.

3. The apparatus of claim 1, wherein the ionic liquid based solvent comprises a cation component and an anion component.

4. The apparatus of claim 3, wherein the anion comprises at least one member selected from chlorides, bromides, iodides, thiocynates, alkylsulfates, hydrogensulfates, and fluorine substituted compounds.

5. The apparatus of claim 4, wherein the fluorine substituted compounds comprise at least one member selected from the group consisting of tetrafluoroborates, hexafluorophosphates, trifluoromethanesulfonates, and trifluoroacetates.

6. The apparatus of claim 3, wherein the cation component comprises a nitrogen or phosphorus based compound.

7. The apparatus of claim 6, wherein the cation component comprises at least one member selected from the group consisting of: mono-substituted imidazoliums, di-substituted imidazoliums, tri-substituted imidazoliums, substituted pyridniums, substituted pyrrolidiniums, tetraalkyl ammoniums, and phosphoniums.

8. A method for storing acetylene, comprising:
a) providing a storage vessel;
b) providing a filler material into the interior or the storage vessel;
c) providing an ionic liquid based solvent into the interior of the storage vessel and in contact with the filler material;
d) filling the storage vessel with acetylene, wherein the pressure inside the storage vessel during the filling is maintained at less than 350 psig.

9. The method of claim 8, further comprising:
a) providing the filler material by introducing the filler material as an aqueous slurry form, wherein the filler material comprises silica lime or a ceramic; and
b) removing water from the aqueous slurry through the addition of heat, to form a porous filler material structure, wherein the porous filler material has a density of about 8-20% of the volume of the storage vessel.

10. The method of claim 8, further comprising providing the ionic liquid in an amount between 25% and 90%, of the volume of the storage vessel.

11. The method of claim 8, further comprising filling the storage vessel with acetylene by contacting the acetylene with the ionic liquid solvent contained in the storage vessel, and dissolving the acetylene into the ionic liquid solvent.

12. The method of claim 11, wherein about 0.20 to about 0.60 grams of acetylene per gram of ionic liquid solvent, as measured at a pressure of about 250 psig, is dissolved.

13. The method of claim 8, wherein the ionic liquid based solvent comprises a cation component and an anion component.

14. The method of claim 13, wherein the anion comprises at least one member selected from chlorides, bromides, iodides, thiocynates, alkylsulfates, hydrogensulfates, and fluorine substituted compounds.

15. The method of claim 14, wherein the fluorine substituted compounds comprise at least one member selected from the group consisting of tetrafluoroborates, hexafluorophosphates, trifluoromethanesulfonates, and trifluoroacetates.

16. The method of claim 13, wherein the cation component comprises a nitrogen or phosphorus based compound.

17. The method of claim 16, wherein the cation component comprises at least one member selected from the group consisting of: mono-substituted imidazoliums, di-substituted imidazoliums, tri-substituted imidazoliums, substituted pyridniums, substituted pyrrolidiniums, tetraalkyl ammoniums, and phosphoniums.

18. The method of claim 8, further comprising withdrawing acetylene from the storage vessel, reducing the pressure of the withdrawn acetylene, and providing the reduced pressure acetylene to a semiconductor manufacturing process.

19. The method of claim 18, further comprising purifying the reduced pressure acetylene prior to providing it to the semiconductor manufacturing process.

20. The method of claim 8, wherein the storage vessel contains no acetone or dimethylformamide.
